(19) United States
(12) Patent Application Publication
(10) Pub. No.: US 2025/0029033 A1
(43) Pub. Date: Jan. 23, 2025

(54) SYSTEM AND METHOD FOR OPTIMIZING AIRPORT OPERATIONS

(71) Applicant: The Boeing Company, Arlington, VA (US)

(72) Inventors: Prasad Rao Piradi, Bengaluru (IN); Bindiya Nagaraj Nidgal, Bangalore (IN); Harish KodhandaRamaiah Setty, Bengaluru (IN); Shahnawaz Mujahid Lone, Bengaluru (IN)

(73) Assignee: The Boeing Company, Arlington, VA (US)

(21) Appl. No.: 18/354,274

(22) Filed: Jul. 18, 2023

(51) Int. Cl. G06Q 10/0631; B64F 1/36

(52) U.S. Cl. CPC G06Q 10/06312; B64F 1/36

(57) ABSTRACT

A method of optimizing ground operations at an airport. The method includes receiving input information regarding the airport where the input information at least includes turnaround process information for aircraft at the airport. An allocation of ground resources and manpower is determined at the airport with a ground resource and manpower model based on the input information. The allocation of ground resources and manpower determined by the ground resource and manpower model with a machine learning model are iteratively optimized until an optimized allocation of ground recourse and manpower is generated that reduces idling of at least one of ground resources or manpower at the airport. A report is generated based on the optimized allocation of ground resources and manpower.

### FIELD

The present disclosure relates to optimizing an allocation of resources for turnaround activities at an airport.

### BACKGROUND

Air traffic is experiencing a tremendous surge with new routes being added almost every day. While growth is a positive sign for aviation, this kind of growth also poses critical challenges like traffic congestion both in the airspace and the airport. Today, congestion and delays have become common situations resulting in high financial costs for the airliners. One way to reduce flight delays is to expand the airport infrastructure, but this takes years to implement successfully and involves high financial costs.

Flight delays not only cause inconvenience to the customer and the airport personnel but also impact airliner's operational costs and profit. An allocation of a given set of resources at the airport influences the airliner's schedule, operation costs, and profit. If delays are reduced, then the associated costs can be minimized. Furthermore, by optimizing turnarounds, airlines can enhance aircraft utilization, resulting in increased revenue. This necessitates the optimization of ground resources and manpower to maximize efficiency and productivity.

### SUMMARY

A method of optimizing ground operations at an airport is disclosed herein. The method includes receiving input information regarding the airport where the input information at least includes turnaround process information for aircraft at the airport. An allocation of ground resources and manpower is determined at the airport with a ground resource and manpower model based on the input information. The allocation of ground resources and manpower determined by the ground resource and manpower model with a machine learning model are iteratively optimized until an optimized allocation of ground recourse and manpower is generated that reduces idling of at least one of ground resources or manpower at the airport. A report is generated based on the optimized allocation of ground resources and manpower.

In one or more embodiments of the method, the machine learning model is generated by a machine learning algorithm trained with a training dataset that includes historical operations information at the airport.

In one or more embodiments of the method, the historical operations information at the airport includes information regarding vehicle resource inventory, manpower inventory, and turnaround activities.

In one or more embodiments of the method, the training dataset includes the input information regarding the airport.

In one or more embodiments of the method, the report includes a turnaround procedures summary having a schedule of activities required to turnaround the aircraft at the airport.

In one or more embodiments of the method, the report includes a flight delay summary identifying a deficiency in resources that will result in a delay of at least one aircraft at the airport.

In one or more embodiments of the method, the report includes a flight schedule summary providing an optimized flight schedule for the airport based on the ground resources and manpower available at the airport.

In one or more embodiments of the method, the turnaround process information includes at least one of a vehicle resource inventory at the airport or a manpower inventory at the airport.

In one or more embodiments of the method, the turnaround process information includes turnaround activities for at least one aircraft at the airport.

In one or more embodiments of the method, the input information includes flight scheduling information for airplanes at the airport.

In one or more embodiments of the method, the input information includes weather conditions at the airport.

In one or more embodiments of the method, the input information includes at least one of an airport layout, airport resources, airport NOTAMS, or gate availability at the airport.

In one or more embodiments of the method, the optimized allocation of ground resources and manpower determined by the ground resource and manpower model is customizable with user preferences.

A non-transitory computer-readable medium embodying programmed instructions which, when executed by a processor, are operable for performing a method is disclosed herein. The method includes receiving input information regarding the airport where the input information at least includes turnaround process information for aircraft at the airport. An allocation of ground resources and manpower is determined at the airport with a ground resource and manpower model based on the input information. The allocation of ground resources and manpower determined by the ground resource and manpower model with a machine learning model are iteratively optimized until an optimized allocation of ground recourse and manpower is generated that reduces idling of at least one of ground resources or manpower at the airport. A report is generated based on the optimized allocation of ground resources and manpower.

In one or more embodiments, the machine learning model is generated by a machine learning algorithm trained with a training dataset that includes historical operations data at an airport.

In one or more embodiments, the training dataset includes the input information regarding an airport.

In one or more embodiments, the report includes a turnaround procedures summary having a schedule of activities required to turnaround the aircraft at the airport.

In one or more embodiments, the report includes a flight delay summary identifying a deficiency in resources that will result in a delay of at least one aircraft at the airport.

In one or more embodiments, the report includes a flight schedule summary providing an optimized flight schedule for an airport based on the ground resources and manpower available at the airport.

In one or more embodiments, the turnaround process information includes at least one of a vehicle resource inventory at the airport or a manpower inventory at the airport.

### DESCRIPTION OF THE DRAWINGS

FIG. 1 illustrates an example method of performing ground resource and manpower modeling.

FIG. 2 illustrates an example user flow for performing the ground resource and manpower modeling illustrated in FIG. 1.

Some embodiments of the present disclosure are now described, by way of example only, and with reference to the accompanying drawings. The same reference number represents the same element or the same type of element on all drawings.

### DESCRIPTION

The Figures and the following description illustrate specific exemplary embodiments of the disclosure. A person of ordinary skill in the art will be able to devise various arrangements that, although not explicitly described or shown herein, embody the principles of the disclosure and are included within the scope of the disclosure. Furthermore, any examples described herein are intended to aid in understanding the principles of the disclosure and are to be construed as being without limitation to such specifically recited examples and conditions. As a result, the disclosure is not limited to the specific embodiments or examples described below but by the claims and their equivalents.

Various embodiments of the disclosure generally provide a system and method for optimizing airport operations. In particular, the system augments and optimizes turnaround ground operations (resources and manpower) to reduce turnaround time for aircraft. The system and method disclosed herein can also generate an optimized flight schedule based on available resources and manpower and improve predictions of resources and manpower required for a given flight schedule based on turnaround activities for each aircraft.

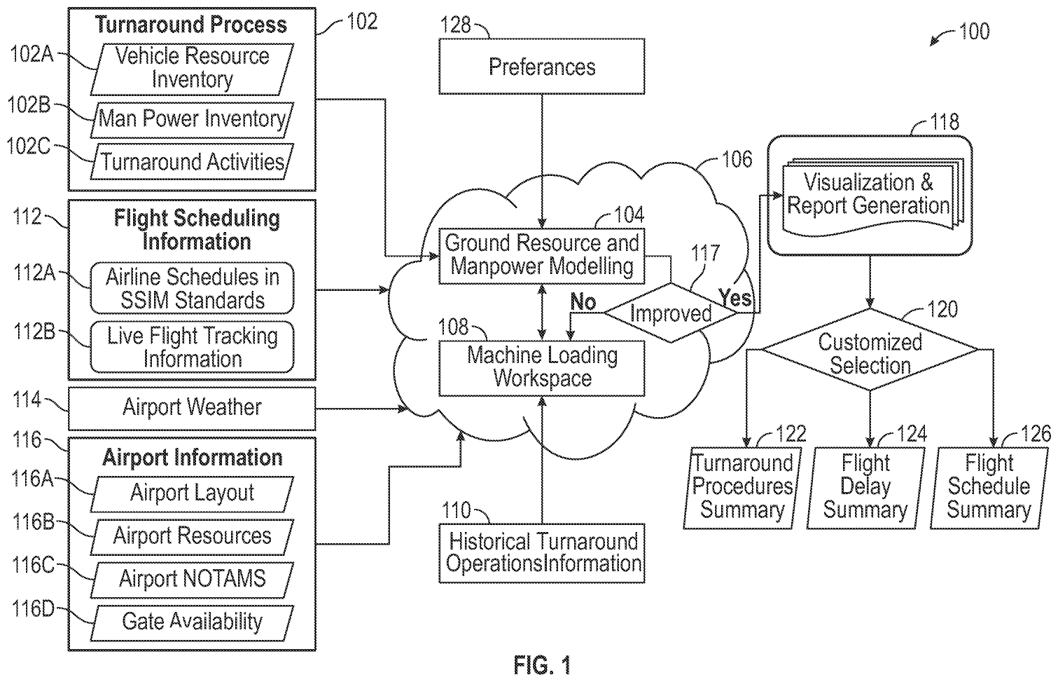

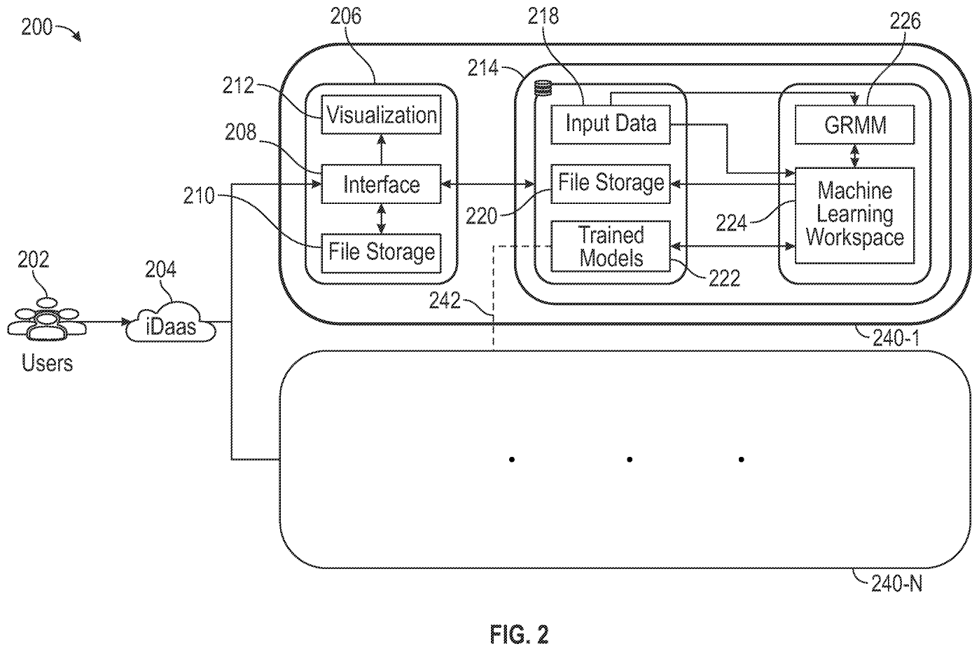

FIG. 1 illustrates an example method 100 of optimizing airport resources through utilizing a ground resource and manpower model (GRMM) at Block 104. In one example, the GRMM (Block 104) can perform a simulation of an allocation of ground resources and manpower for a given set of ground operations to determine an effectiveness in the allocation of resources. A system 200 (FIG. 2) employs the disclosed method 100 to optimize the allocation of ground resources and manpower at an airport. This includes ground-based machinery/equipment and ground staff resources. The objective is to reduce airplane turnaround time and enhance resource allocation, leading to improved operational efficiency. One feature of implementing the disclosed method 100 is improved efficiency of airports without changes to infrastructure at the airport, which can be expensive and require years to plan and complete.

Any of the various control elements (e.g., electrical, or electronic components) shown in the figures or described herein may be implemented as hardware, a processor implementing software, a processor implementing firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-transitory computer readable medium, non-volatile storage, logic, or some other physical hardware component or module.

To generate the optimized allocation of ground resources and manpower with the method 100, different types of input information are provided to the GRMM at Block 104. In one example, the input information includes turnaround process information (Block 102). The turnaround process information can include at least one of a vehicle resource inventory (Block 102A), a manpower inventory (Block 102B), or turnaround activities (Block 102C).

The vehicle resource inventory can include the number of vehicles available at the airport for carrying out operations at the airport. The manpower inventory can include the number of ground staff along with their associated skills for carrying out operations at the airport. The turnaround activities can include activities for preparing an aircraft for the next flight, such as cleaning, fueling, and restocking of supplies. In one example, the input information (Block 102) is provided to the GRMM (Block 104) through internet of things (IoT) devices forming a connection, such as through the internet, with the GRMM (Block 104) in the cloud server (Block 106).

The GRMM (Block 104) and the machine learning workspace (Block 108) can also access flight scheduling information (Block 112), airport weather information (Block 114), and airport information (Block 116). In the illustrated example, the flight scheduling information includes Standard Schedules Information Manual SSIM (Block 112A) and live flight tracking information (Block 112B). The airport information (Block 116) includes an airport layout (Block 116A), airport resources (Block 116B), airport notice to air missions (NOTAMS) (Block 116C), and gate availability (Block 116D).

Furthermore, the machine learning workspace (Block 108) can access historical turnaround operations information from Block 110. The historical turnaround operations information (Block 110) can include information regarding past allocations at the airport of the vehicle resource and the manpower along with the associated turnaround activities for the aircraft.

The turnaround process information (Block 102), the flight scheduling information (Block 112), the airport weather information (Block 114), the airport information (Block 116), and the historical turnaround operations information (Block 110) can form a training dataset for the machine learning workspace (Block 108). The training dataset can be utilized for training a machine learning algorithm to develop a machine learning model in the machine learning workspace (Block 108) for iteratively optimizing an allocation of ground resources and manpower with the GRMM (Block 104). In the illustrated example, the development of the machine learning model occurs in the cloud server (Block 106). However, the machine learning model could be performed locally on a piece of hardware depending on the application.

Preferences (Block 128) for the allocation of ground resources and manpower can be provided to the GRMM (Block 104) to guide the GRMM in optimizing the allocation to meet a predetermined requirement of the user or airline. The preferences can also include a direction to use multiple skill levels of manpower resources, to train idle manpower resources, or other specific preferences for resource allocation.

The GRMM (Block 104) can create a summary for each allocation of resources that can be used for comparison with the next iteration in the GRMM. The summary of ground staff resources can illustrate how manpower resources are allocated to a particular resource type and sum up the total manpower in different statuses such as in use, waiting, moving, idle, allocated, or unavailable to determine if the latest iteration is an improvement.

To generate the optimized allocation of ground resources and manpower, the machine learning model from the machine learning workspace (Block 108) performs an iterative computation with the GRMM (Block 104). Each iteration of the allocation of ground resources and manpower is evaluated at Block 117. If the optimized allocation evaluated at Block 117 does not result in an improved allocation of resources, then a further iteration is performed with the machine learning workspace (Block 108) and the GRMM (Block 104). If the optimized allocation produces a better allocation at Block 117, the method 100 proceeds to Block 118 to generate at least one report or visualizations based on the optimized allocation. In one example, the better allocation is reached when the optimized allocation of ground recourses and manpower generated reduces idling of at least one of ground resource or manpower at the airport when compared to a previous allocation. Furthermore, a predetermined threshold in reduction could be used to determine when to stop iterating between the machine learning workspace (Block 108) and the GRMM (Block 104).

The optimized allocation can be stored in a binary large object service. The trained machine learning model can also be stored for use in further improving the machine learning logic to build an image with mode and dependencies. In the illustrated example, reports from the optimized allocation of resources could include a customized section 120 with at least one of a “Turnaround Procedures Summary” (Block 122), a “Flight Delay Summary” (Block 124), or a “Flight Schedule Summary” (Block 126).

The turnaround procedures summary 122 provides a proposed model that accurately predicts the manpower and resources required to smoothly execute a set of turnaround operations for a given duration of time. The flight delay summary 124 identifies deficiencies in resources that will result in a delay of at least one aircraft at the airport. The flight schedule summary 126 provides an optimized flight schedule for the airport based on the ground resources and manpower available at the airport.

The method 100 can also generate a flight schedule based on the available resources and accurately estimate the number of resources needed to carry out individual or multiple activities within a specific timeframe. This includes tasks such as efficiently managing aircraft turnarounds. The system 200 incorporating the method 100 is compatible with external tools, such as mobile devices, to improve resource allocation as will be discussed further below.

In one example implementation of the method 100, an airliner has more manpower than required at a particular point of time which results in an inefficient usage of available resources by idling resources or having resources wait for prior process to complete. The method 100 described above, learns progressively from the interaction of GRMM (Block 104) with the machine learning workspace (Block 108) and the information stored in the cloud server (Block 106) to improve the optimization of resources on each iteration. The method 100 is capable of identifying scenarios when there are idle resources and then by allocating those resources to various ongoing tasks that are currently being executed either in the resource area of expertise or at other areas of work resulting in faster execution of the current assigned task by increasing the skill set of manpower resource by training them. This further allows the method 100 to prepare and address unseen scenarios. One such scenario is when the airliner is facing a shortage of manpower of a particular skill set and determine how training idle manpower would remedy the situation in the future.

In another example implementation of the method 100, the allocation of resources tends to increase a skillset of the manpower, when possible, instead of idling the manpower resource if the skillset of the available manpower resource does not meet the current need. In this case, an airliner may have a shortage of manpower resources of a particular skillset, such as fueling, catering, cargo etc. at any given point of time. With the method 100, the airliner would increase the skillset of the available manpower resources due to the method 100 being able to assign idled manpower resources to learn new skillsets that will reduce delays or shortages in manpower of a given skillset in the future.

FIG. 2 illustrates the system 200 implementing the method 100 as software as a service over a Cloud Computing Service (CCS). With the example system 200, users (Block 202) are authenticated on the system 200 using Identify-as-a-service (IDaaS) (Block 204) through a user device 206, such as a tablet or smart phone. Once the users are successfully authenticated, the users are redirected to a user interface (Block 208), such as a homepage on a web application, that appears on the user device 206. From the interface (Block 208), the user is directed to provide various types of input information or data (Block 218), such as turnaround process information (See Block 102), flight scheduling information (See Block 112), airport weather (See Block 114), or airport information (See Block 116) as discussed above with the method 100. This information can be temporarily stored in a file storage system (Block 220) in a cloud server (Block 214) with each file being given a unique identifier. In the illustrated example, the user is associated with a particular region (Block 240-1) corresponding to at least one airport.

In one example, the interface (Block 208) can also include various input fields, such as resource type, aircraft type, aircraft category, number of personnel to be allocated, manpower resource experience, skill set, shift, or etc. The input fields can also be populated with predetermined information files, such as files including the manpower resources, the flight schedule, or the turnaround process. In one example, a built in “turnaround process” file could be used when no “turnaround process” file or input information is provided by the user or airliner. Furthermore, the airliner can either alter the default “turnaround process” file or import a new one as desired.

The system 200 can also allow the user or airliner to input predetermined rules for assigning resources or allow the system 200 to assign predetermined rules. The system 200 can also provide preferences for resource allocation when generating the optimized allocation of ground resources and manpower, such as priority between international flights vs. domestic flights, cargo vs. passenger flights, or multi-leg vs. single-leg flights. Also, if the system 200 observes that there are additional resources or idle resources, the system 200 can automatically allocate those resources to other areas of work enabling manpower resources to gain enhanced skill sets through experience in varying fields.

The input fields accessible to the users can include a “manpower resource type” field which indicates various skills possessed by the ground staff. Also, the ground staffs level of expertise in each skill can be indicated by an “experience” field. The user will be able to interact with the system through the interface (Block 208) to make changes to the input information before it is processed on the cloud server (Block 214). Having the input information processed on the cloud server (Block 214) reduces redundancy in calculations by eliminating the requirement to have each user perform the core logic and calculations of the GRMM (Block 226) and machine learning workspace (Block 224) as described above with respect to the method 100. This also reduces the computing power required for the user devices (206).

Once all the required input information is provided to the system 200, the system 200 directs the machine learning workspace (Block 224) to perform an iterative computation with the GRMM (Block 226) to generate the optimized allocation of ground resources and manpower. The machine learning model in the machine learning workspace (Block 224) is trained as discussed above with respect to the method 100.

Once the iterative computation is complete, the output results are stored in the file storage system (Block 220). The trained models (Block 222) can also be stored on the cloud server (Block 214) for use in further improving the machine learning logic in the machine learning workspace (Block 224). In particular, the trained machine learning models (Block 222) can be shared with models from other regions (Block 240-N) along line 242.

The optimized allocation of ground resources and manpower can include at least one of a turnaround procedures summary, a flight delay summary, or a flight schedule summary as discussed above. At least one of these summaries can be provided to the user through an interactive data visualization (Block 212), such as with PowerBI or Tableau, for analysis. The visualizations (Block 212) can provide insights into how the manpower has been utilized, the flight delay status, and turnaround status, including summaries detailing the various aspects of manpower, aircraft, and resources be used or idled. This detailed status helps in decision making for better allocation of resources thus reducing the overall turnaround time resulting in fewer or shorter flight delays. One feature of the system 200 is that it can reduce deadlock of manpower unavailability for a particular skill set by allocating another manpower resource possessing the required skill set.

The above summaries can also illustrate the resource details and status of a given summary. The resource details represent the activity which is ongoing for an allocated resource type. Resource status can represent details of all resources allocated to a particular resource type thus deciding the total resources in different statuses such as in use, waiting, moving, idle, allocated and unavailable.

As the ground resource staff are largely mobile and are directed to various locations on a continuously updated timeframe, the system 200 operates largely through cloud server 214 with wireless communication to the mobile devices 206, such as smart phones or tablets, for directing the ground resources.

The following Clauses provide example configurations of systems and methods for an example method 100 of optimizing airport resources of FIG. 1.

Clause 1: A method of optimizing ground operations at an airport, the method comprising: receiving input information regarding the airport, wherein the input information at least includes turnaround process information for aircraft at the airport; determining an allocation of ground resources and manpower at the airport with a ground resource and manpower model based on the input information; iteratively optimizing the allocation of ground resources and manpower determined by the ground resource and manpower model with a machine learning model until an optimized allocation of ground recourse and manpower is generated that reduces idling of at least one of ground resources or manpower at the airport; and generating a report based on the optimized allocation of ground resources and manpower.

Clause 2: The method of clause 1, wherein the machine learning model is generated by a machine learning algorithm trained with a training dataset that includes historical operations information at the airport.

Clause 3: The method of any of clauses 1-2, wherein the historical operations information at the airport includes information regarding vehicle resource inventory, manpower inventory, and turnaround activities.

Clause 4: The method of any of clauses 1-3, wherein the training dataset includes the input information regarding the airport.

Clause 5: The method of any of clauses 1-4, wherein the report includes a turnaround procedures summary having a schedule of activities required to turnaround the aircraft at the airport.

Clause 6: The method of any of clauses 1-5, wherein the report includes a flight delay summary identifying a deficiency in resources that will result in a delay of at least one aircraft at the airport.

Clause 7: The method of any of clauses 1-6, wherein the report includes a flight schedule summary providing an optimized flight schedule for the airport based on the ground resources and manpower available at the airport.

Clause 8: The method of any of clauses 1-7, wherein the turnaround process information includes at least one of a vehicle resource inventory at the airport or a manpower inventory at the airport.

Clause 9: The method of any of clauses 1-8, wherein the turnaround process information includes turnaround activities for at least one aircraft at the airport.

Clause 10: The method of any of clauses 1-9, wherein the input information includes flight scheduling information for airplanes at the airport.

Clause 11: The method of any of clauses 1-10, wherein the input information includes weather conditions at the airport.

Clause 12: The method of any of clauses 1-11, wherein the input information includes at least one of an airport layout, airport resources, airport NOTAMS, or gate availability at the airport.

Clause 13: The method of any of clauses 1-12, wherein the optimized allocation of ground resources and manpower determined by the ground resource and manpower model is customizable with user preferences.

Clause 14: A non-transitory computer-readable medium embodying programmed instructions which, when executed by a processor, are operable for performing a method comprising: receiving input information regarding the airport, wherein the input information at least includes turnaround process information for aircraft at the airport; determining an allocation of ground resources and manpower at the airport with a ground resource and manpower model based on the input information; iteratively optimizing the allocation of ground resources and manpower determined by the ground resource and manpower model with a machine learning model until an optimized allocation of ground recourses and manpower is generated that reduces idling of at least one of ground resources or manpower at the airport; and generating a report based on the optimized allocation of ground resources and manpower.

Clause 15: The computer-readable medium of clause 14, wherein the machine learning model is generated by a machine learning algorithm trained with a training dataset that includes historical operations data at an airport.

Clause 16: The computer-readable medium of any of clauses 14-15, wherein the training dataset includes the input information regarding an airport.

Clause 17: The computer-readable medium of any of clauses 14-16, wherein the report includes a turnaround procedures summary having a schedule of activities required to turnaround the aircraft at the airport.

Clause 18: The computer-readable medium of any of clauses 14-17, wherein the report includes a flight delay summary identifying a deficiency in resources that will result in a delay of at least one aircraft at the airport.

Clause 19: The computer-readable medium of any of clauses 14-18, wherein the report includes a flight schedule summary providing an optimized flight schedule for an airport based on the ground resources and manpower available at the airport.

Clause 20: The computer-readable medium of any of clauses 14-19, wherein the turnaround process information includes at least one of a vehicle resource inventory at the airport or a manpower inventory at the airport.

While various embodiments have been described, the description is intended to be exemplary rather than limiting. It will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What is claimed is:

1. A method of optimizing ground operations at an airport, the method comprising:
receiving input information regarding the airport, wherein the input information at least includes turnaround process information for aircraft at the airport;
determining an allocation of ground resources and manpower at the airport with a ground resource and manpower model based on the input information;
iteratively optimizing the allocation of ground resources and manpower determined by the ground resource and manpower model with a machine learning model until an optimized allocation of ground recourse and manpower is generated that reduces idling of at least one of ground resources or manpower at the airport; and
generating a report based on the optimized allocation of ground resources and manpower.

2. The method of claim 1, wherein the machine learning model is generated by a machine learning algorithm trained with a training dataset that includes historical operations information at the airport.

3. The method of claim 2, wherein the historical operations information at the airport includes information regarding vehicle resource inventory, manpower inventory, and turnaround activities.

4. The method of claim 2, wherein the training dataset includes the input information regarding the airport.

5. The method of claim 1, wherein the report includes a turnaround procedures summary having a schedule of activities required to turnaround the aircraft at the airport.

6. The method of claim 1, wherein the report includes a flight delay summary identifying a deficiency in resources that will result in a delay of at least one aircraft at the airport.

7. The method of claim 1, wherein the report includes a flight schedule summary providing an optimized flight schedule for the airport based on the ground resources and manpower available at the airport.

8. The method of claim 1, wherein the turnaround process information includes at least one of a vehicle resource inventory at the airport or a manpower inventory at the airport.

9. The method of claim 8, wherein the turnaround process information includes turnaround activities for at least one aircraft at the airport.

10. The method of claim 1, wherein the input information includes flight scheduling information for airplanes at the airport.

11. The method of claim 1, wherein the input information includes weather conditions at the airport.

12. The method of claim 1, wherein the input information includes at least one of an airport layout, airport resources, airport NOTAMS, or gate availability at the airport.

13. The method of claim 1, wherein the optimized allocation of ground resources and manpower determined by the ground resource and manpower model is customizable with user preferences.

14. A non-transitory computer-readable medium embodying programmed instructions which, when executed by a processor, are operable for performing a method comprising:
receiving input information regarding an airport, wherein the input information at least includes turnaround process information for aircraft at the airport;
determining an allocation of ground resources and manpower at the airport with a ground resource and manpower model based on the input information;
iteratively optimizing the allocation of ground resources and manpower determined by the ground resource and manpower model with a machine learning model until an optimized allocation of ground recourses and manpower is generated that reduces idling of at least one of ground resources or manpower at the airport; and
generating a report based on the optimized allocation of ground resources and manpower.

15. The computer-readable medium of claim 14, wherein the machine learning model is generated by a machine learning algorithm trained with a training dataset that includes historical operations data at an airport.

16. The computer-readable medium of claim 15, wherein the training dataset includes the input information regarding an airport.

17. The computer-readable medium of claim 14, wherein the report includes a turnaround procedures summary having a schedule of activities required to turnaround the aircraft at the airport.

18. The computer-readable medium of claim 14, wherein the report includes a flight delay summary identifying a deficiency in resources that will result in a delay of at least one aircraft at the airport.

19. The computer-readable medium of claim 14, wherein the report includes a flight schedule summary providing an optimized flight schedule for an airport based on the ground resources and manpower available at the airport.

20. The computer-readable medium of claim 14, wherein the turnaround process information includes at least one of a vehicle resource inventory at the airport or a manpower inventory at the airport.
